(19) United States
(12) Patent Application Publication
(10) Pub. No.: US 2021/0341774 A1
(43) Pub. Date: Nov. 4, 2021

(54) LIQUID CRYSTAL DISPLAY DEVICE

(71) Applicant: Shenzhen China Star Optoelectronics Semiconductor Display Technology Co., Ltd., Shenzhen (CN)

(72) Inventor: Jiangchuan Chen, Shenzhen (CN)

(73) Assignee: Shenzhen China Star Optoelectronics Semiconductor Display Technology Co., Ltd., Shenzhen (CN)

(21) Appl. No.: 16/625,167

(22) PCT Filed: Dec. 17, 2019
(86) PCT No.: PCT/CN2019/125863

§ 371 Date: Dec. 20, 2019

(30) Foreign Application Priority Data
Dec. 6, 2019 (CN) 201911238411.3

(51) Int. Cl. G02F 1/1347; G02F 1/1335

(52) U.S. Cl. CPC G02F 1/1347; G02F 2202/28; G02F 1/133514; G02F 1/133528

(57) ABSTRACT

The present invention provides a liquid crystal display device, which includes a backlight module, a first liquid crystal panel, and a second liquid crystal panel wherein the second liquid crystal panel is configured to serve as a screen display panel of the liquid crystal display device. In the present application, the deflection direction of the first liquid crystal layer is driven by the first pixel structure layer of the first liquid crystal panel, to further control polarization characteristics of light of the backlight module, so that the second liquid crystal panel achieves an absolute black state and improves the contrast of the liquid crystal display device.

### BACKGROUND OF INVENTION

### Field of Invention

The present invention relates to a technical field of flat display, and in particular to a liquid crystal display device

### Description of Prior Art

With continuous development of display technology, new flat displays have begun to completely replace cathode ray tube (CRT) displays and become mainstream display devices on the market.

The flat displays first accepted by the market are flat liquid crystal displays (LCDs), which due to their lightness and thinness, have made them quickly accepted by the market, and have gained widespread application as well as a high market share.

However, a contrast of the traditional liquid crystal display is low, thus failing to comply with the needs of users.

### SUMMARY OF INVENTION

An object of the present invention is to provide a liquid crystal display device which adopts a new display architecture, thereby realizing high-contrast display.

Technical schemes adopted by the present invention are as follows:

A liquid crystal display device, including: a backlight module; a first liquid crystal panel disposed on a light-exiting side of the backlight module; and a second liquid crystal panel disposed on a surface of the first liquid crystal panel away from the backlight module and configured to serve as a screen display panel of the liquid crystal display device, wherein the first liquid crystal panel includes: a first substrate; a second substrate disposed opposite to the first substrate, the second substrate being a bare glass substrate; and a first liquid crystal layer disposed between the first substrate and the second substrate, wherein the first substrate is provided with a first pixel structure layer to drive liquid crystal deflection of the first liquid crystal layer; and

the first pixel structure layer includes a first pixel unit.

Further, the first pixel structure layer drives the first liquid crystal layer to rotate in a plane parallel to the first substrate.

Further, the liquid crystal display device further includes: a first polarizer disposed between the first liquid crystal panel and the backlight module.

Further, the liquid crystal display device further includes: a second polarizer disposed between the first liquid crystal panel and the second liquid crystal panel; and a third polarizer disposed on a surface of the second liquid crystal panel away from the first liquid crystal panel, wherein, the second polarizer has a polarization direction perpendicular to a polarization direction of the third polarizer.

Further, the second liquid crystal panel includes: a third substrate; a fourth substrate disposed opposite to the third substrate; and a second liquid crystal layer disposed between the third substrate and the fourth substrate, wherein the third substrate is provided with a second pixel structure layer to drive liquid crystal deflection of the second liquid crystal layer, and the second pixel structure layer includes a second pixel unit; the fourth substrate is provided with a color filter layer, and the color filter layer includes a red filter layer, a green filter layer, and a blue filter layer; the second pixel unit is provided with a first sub-pixel unit, a second sub-pixel unit, and a third sub-pixel unit respectively correspond to the red filter layer, the green filter layer, and the blue filter layer.

Further, the first pixel unit of the first liquid crystal panel and the second pixel unit of the second liquid crystal panel have a same shape and a same size.

Further, the first pixel unit of the first liquid crystal panel is disposed opposite to the second pixel unit of the second liquid crystal panel.

Further, the second liquid crystal panel is attached to the first liquid crystal panel by a transparent adhesive.

Further, the transparent adhesive includes one or more of organic resin and siloxane.

Further, the transparent adhesive has a thickness ranging from 4 μm to 10 μm.

The present invention relates to a liquid crystal display device, which adopts a novel double-cell display structure constituted by a first liquid crystal panel and a second liquid crystal panel which are stacked, wherein the second liquid crystal panel is configured to serve as a screen display panel of the liquid crystal display device. In the present application, the deflection direction of the first liquid crystal layer is driven by the first pixel structure layer of the first liquid crystal panel, to further control polarization characteristics of light of the backlight module, so that the second liquid crystal panel achieves an absolute black state and improves the contrast of the liquid crystal display device. Meanwhile, since the color display of the liquid crystal display device is realized by the second liquid crystal panel, the second substrate of the first liquid crystal panel may be a bare glass substrate, which to a certain extent, not only saves the production cost of the liquid crystal display device, but also reduces the overall thickness of the liquid crystal display device.

### BRIEF DESCRIPTION OF DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

FIG. 1 is a schematic structural diagram of a liquid crystal display device according to an embodiment of the present invention.

FIG. 2 is a schematic structural diagram of a first pixel unit of a first pixel structure layer in a liquid crystal display device.

FIG. 3 is a schematic structural diagram of a second pixel unit of a second pixel structure layer in a liquid crystal display device.

### DETAILED DESCRIPTION OF PREFERRED EMBODIMENTS

The technical solution of a liquid crystal display device according to the present invention will be further described in detail below with reference to the accompanying drawings and embodiments.

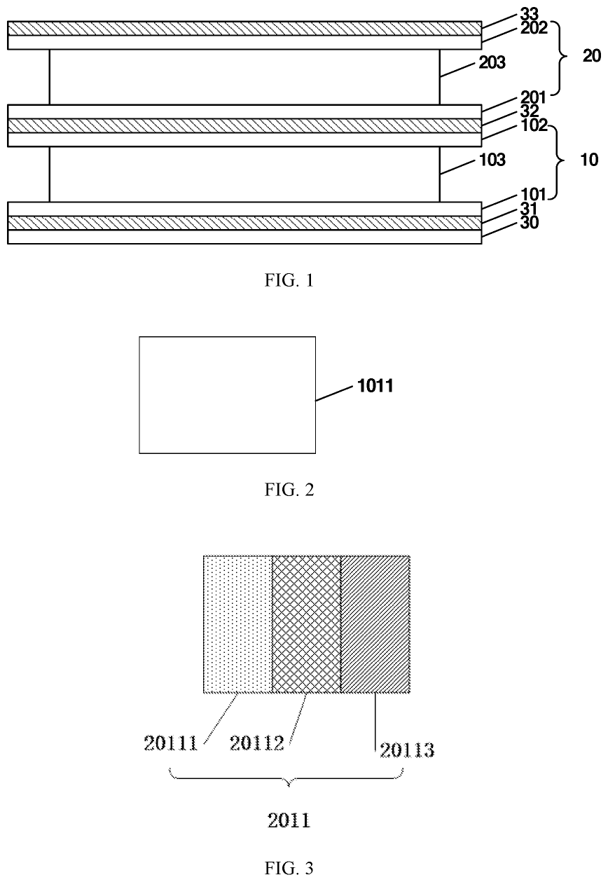

As shown in FIG. 1, this embodiment provides a liquid crystal display device, which includes a first liquid crystal panel 10, a second liquid crystal panel 20, and a backlight module 30.

As shown in FIG. 1, the first liquid crystal panel 10 is disposed on a light-exiting side of the backlight module 30. The second liquid crystal panel 20 is disposed on a surface of the first liquid crystal panel 10 away from the backlight module 30. The first liquid crystal panel 10 and the second liquid crystal panel 20 are bonded with each other by a transparent adhesive. The specific material used for the transparent adhesive is preferably a transparent adhesive material such as organic resin or siloxane, but may also be other transparent adhesive materials known in the industry, and the specific material may be determined as needed, which is not particularly limited.

The transparent adhesive may have a specific thickness of 4-10 μm, and preferably 6 μm. A liquid crystal cell of the first liquid crystal panel 10 may have a thickness of 2-5 um, and the liquid crystal cell of the second liquid crystal panel 20 may also have a thickness of 2-5 um. When the thickness of the transparent adhesive is less than 4 μm, adhesion effect between the first liquid crystal panel 10 and the second liquid crystal panel is impacted, resulting in a risk of falling off; while when the thickness of the transparent adhesive is greater than 10 μm, material is wasted and cost is increased.

The first liquid crystal panel 10 includes: a first substrate 101; a second substrate 102 disposed opposite to the first substrate 101; and a first liquid crystal layer 103 disposed between the first substrate 101 and the second substrates 102. The first substrate 101 is provided with a first pixel structure layer to drive liquid crystal deflection of the first liquid crystal layer 103; and the first pixel structure layer includes a first pixel unit 1011. In the present application, the deflection direction of the first liquid crystal layer is driven by the first pixel structure layer of the first liquid crystal panel, to further control polarization characteristics of light of the backlight module, so that the second liquid crystal panel achieves an absolute black state and improves the contrast of the liquid crystal display device. Meanwhile, since the second substrate 102 may be a bare glass substrate, that is, the second substrate 102 is not provided with any structure including a color filter layer, which to a certain extent, not only saves the production cost of the liquid crystal display device, but also reduces the overall thickness of the liquid crystal display device.

The first pixel structure layer drives the first liquid crystal layer 103 to rotate in a plane parallel to the first substrate 101. The first liquid crystal panel 10 adopts a horizontal electric field display mode, and the horizontal electric field display mode includes one or more of IPS, FFS, and a derived horizontal electric field display mode.

The second liquid crystal panel 20 includes a third substrate 201, a fourth substrate 202 disposed opposite to the third substrate 201, and a second liquid crystal layer 203 disposed between the third substrate 201 and the fourth substrate 202. The third substrate 201 is provided with a second pixel structure layer to drive liquid crystal deflection of the second liquid crystal layer 203; and the second pixel structure layer includes a second pixel unit 2011. The fourth substrate 202 is provided with a color filter layer, and the color filter layer includes a red filter layer, a green filter layer, and a blue filter layer. The second pixel unit 2011 is provided with the first sub-pixel unit 20111, the second sub-pixel unit 20112, and the third sub-pixel unit 20113 correspond to the red filter layer, the green filter layer, and the blue filter layer, respectively. In this embodiment, the second liquid crystal panel 20 is used as a display panel of a liquid crystal display device, and is configured to perform color display according to polarized light emitted from the first liquid crystal panel 10.

Specifically, the color filter layer may further include a yellow filter layer, and the second pixel unit 2011 is further provided with a fourth sub-pixel unit corresponding to the yellow filter layer, Alternatively, the color filter layer may further include a white filter layer, and the second pixel unit 2011 may further include a fourth sub-pixel unit corresponding to the white filter layer.

Further, the first pixel unit 1011 of the first liquid crystal panel 10 and the second pixel unit 2011 of the second liquid crystal panel 20 have the same shape and the same size and are oppositely disposed. In this embodiment, the size and shape of the first pixel unit 1011 of the first liquid crystal panel 10 are designed to be the same as those of the second pixel unit 2011 of the second liquid crystal panel 20, and the two are oppositely disposed such that the polarized light emitted from the first liquid crystal panel 10 can be accurately incident on the opening area of the second liquid crystal panel 20 to avoid problems such as light leakage from the second liquid crystal display panel 20. The first liquid crystal panel 10 itself does not need to be provided with a color filter for filtering operation, thereby to a certain extent, saving the production cost of the liquid crystal display device where it is located and reducing the overall thickness of the liquid crystal display device where it is located.

A first polarizer 31 is disposed between the first liquid crystal panel 10 and the backlight module 30, which is a lower polarizer of the first liquid crystal panel 10. An upper surface of the first liquid crystal panel 10 is provided with no upper polarizer. The light emitted by the backlight module 30 has multiple directions. When the light emitted by the backlight module 30 passes through the first polarizer 31, it will enter the first liquid crystal panel 10 in a direction parallel to the polarization direction of the first polarizer 31.

Lower and upper sides of the second liquid crystal panel 20 are both provided with polarizers, which are the second polarizer 32 between the first liquid crystal panel 10 and the second liquid crystal panel 20, and third polarizer 33 disposed on a surface of the liquid crystal panel 20 away from the the first liquid crystal panel 10, wherein a polarization direction of the second polarizer 32 is perpendicular to a polarization direction of the third polarizer 33. The polarization direction of the first polarizer 31 may be the same as the polarization direction of the second polarizer 32, or perpendicular to the polarization direction of the second polarizer 32.

In this embodiment, when the light emitted by the backlight module 30 enters the first polarizer 31 of the first liquid crystal panel 10, it becomes linearly polarized light. Since the first liquid crystal panel 10 uses a horizontal electric field drive type display mode such as IPS/FFS, in this display mode, the liquid crystal layer of the first liquid crystal panel 10 can be regarded as a λ/2 wave plate, and a rotation angle of liquid crystal molecules in the liquid crystal layer can control a polarization angle of the light emitted from the first liquid crystal panel 10. For example, when a deflection angle of the liquid crystal molecules is 0, the first liquid crystal panel 10 has almost no outgoing light. In such a case, the second liquid crystal panel 20 has almost no incident light, so that the second liquid crystal panel 20 achieves an excellent “black state” to increase the contrast of the liquid crystal display device.

When the first pixel structure layer drives the first liquid crystal layer 103 to rotate in a plane parallel to the first substrate 101, after linearly polarized light transmitted through the first polarizer 31 of the first liquid crystal panel 10 passes the first liquid crystal layer 103, it becomes an elliptically polarized state, that is, the polarization characteristics of the linearly polarized light transmitted through the first polarizer 31 are converted by the polarization characteristics of the first liquid crystal layer 103 of the first liquid crystal panel 10, such that light at various angles is incident to the second polarizer 32 of the second liquid crystal panel 20 to achieve high-contrast color display of the second liquid crystal panel 20.

Specifically, for example, assuming that the first liquid crystal panel 10 and the second liquid crystal panel 20 both have contrast ratios of 1000:1, and have black-white state transmittances of 5% and 0.05%, respectively, after the first liquid crystal panel 10 and the second liquid crystal panel 20 are bonded with each other, theoretically, the contrast value of the entire liquid crystal display device constituted by the two can be CR=L_{white state}/L_{black state}=5%*5%/(0.05%*0.05%)=1000,000:1, which indicates that the new liquid crystal display device provided by the present application can achieve high contrast display.

The technical scope of the present invention is not particularly limited to the content of the above description. Those skilled in the art can make various modifications and modifications to the above embodiments without departing from the technical idea of the present invention, and these modifications and modifications should all within the scope of the present invention.

What is claimed is:

1. A liquid crystal display device, comprising:
a backlight module;
a first liquid crystal panel disposed on a light exiting side of the backlight module; and
a second liquid crystal panel disposed on a surface of the first liquid crystal panel away from the backlight module and configured to serve as a screen display panel of the liquid crystal display device,
wherein the first liquid crystal panel comprises:
a first substrate;
a second substrate disposed opposite to the first substrate, the second substrate being a bare glass substrate; and
a first liquid crystal layer disposed between the first substrate and the second substrate,
wherein the first substrate is provided with a first pixel structure layer to drive liquid crystal deflection of the first liquid crystal layer; and
the first pixel structure layer comprises a first pixel unit.

2. The liquid crystal display device according to claim 1, wherein the first pixel structure layer drives the first liquid crystal layer to rotate in a plane parallel to the first substrate.

3. The liquid crystal display device according to claim 2, further comprising: a first polarizer disposed between the first liquid crystal panel and the backlight module.

4. The liquid crystal display device according to claim 3, further comprising:
a second polarizer disposed between the first liquid crystal panel and the second liquid crystal panel; and
a third polarizer disposed on a surface of the second liquid crystal panel away from the first liquid crystal panel,
wherein, the second polarizer has a polarization direction perpendicular to a polarization direction of the third polarizer.

5. The liquid crystal display device according to claim 4, wherein the second liquid crystal panel comprises:
a third substrate;
a fourth substrate disposed opposite to the third substrate; and
a second liquid crystal layer disposed between the third substrate and the fourth substrate,
wherein the third substrate is provided with a second pixel structure layer to drive liquid crystal deflection of the second liquid crystal layer, and the second pixel structure layer comprises a second pixel unit;
the fourth substrate is provided with a color filter layer, and the color filter layer comprises a red filter layer, a green filter layer, and a blue filter layer;
the second pixel unit is provided with a first sub-pixel unit, a second sub-pixel unit, and a third sub-pixel unit respectively correspond to the red filter layer, the green filter layer, and the blue filter layer.

6. The liquid crystal display device according to claim 5, wherein the first pixel unit of the first liquid crystal panel and the second pixel unit of the second liquid crystal panel have a same shape and a same size.

7. The liquid crystal display device according to claim 6, wherein the first pixel unit of the first liquid crystal panel is disposed opposite to the second pixel unit of the second liquid crystal panel.

8. The liquid crystal display device according to claim 1, wherein the second liquid crystal panel is attached to the first liquid crystal panel by a transparent adhesive.

9. The liquid crystal display device according to claim 8, wherein the transparent adhesive comprises one or more of organic resins and siloxanes.

10. The liquid crystal display device according to claim 8, wherein the transparent adhesive has a thickness ranging from 4 μm to 10 μm.
